(19) United States
(12) Patent Application Publication
(10) Pub. No.: US 2005/0050357 A1
(43) Pub. Date: Mar. 3, 2005

(54) Method and system for detecting unauthorized hardware devices

(76) Inventors: Su-Huei Jeng, Taina City (TW); Cuang-Liang Dai, Yongkang City (TW)

Correspondence Address: THOMAS, KAYDEN, HOSTEMEYER & RISLEY LLP, 100 GALLERIA PARKWAY, SUITE 1750, ATLANTA, GA, 30339, US

(21) Appl. No.: 10/653,302

(22) Filed: Sep. 2, 2003

(51) Int. Cl. G06F 11/30

(52) U.S. Cl. 713/201

(57) ABSTRACT

A system for detecting unauthorized hardware devices in a local area network. A device detection unit scans ports of network devices to calculate the number of ports with more than two MAC addresses. A device processing unit subtracts the number of ports with more than two authorized MAC addresses from the number of total ports (including authorized and unauthorized) with more than two MAC addresses to obtain a listing of unauthorized MAC addresses, and thereby ascertain identities of unauthorized hardware devices.

### BACKGROUND OF THE INVENTION

1. Field of the Invention

The present invention relates to a method for detecting unauthorized hardware devices, and in particular to a method for detecting and identifying unauthorized hardware devices in a local area network (LAN).

2. Description of the Related Art

While computer networks provide convenience, they can present potential harm without proper management. Network security concerns itself with physical security, data security, system and program security, as well as other security issues. Physical security generally relates to the securing of devices in system control environments. Data security generally concerns itself with inconsistency, and input checking for data processing, and applications for data encryption. System and program security comprises alteration management and issue management. One major problem with computer networks open to public access is reliance on human management, involving measures for firewalls, network security monitoring, virus defense, and data encryption management.

Networking is indispensable for business management, with important focus on Intranet construction and use, implemented by virtual private networks (VPN) utilizing the backbone of the public network for private data transmission. Encryption measures are thus very important in virtual private networks to secure data.

A major advantage of VPNs is simplification of network management. For example, a large company may have a multitude of computer devices connected to each other via a LAN to share resources and enable central control management. For a manufacturing enterprise with many employees, each employee is typically allocated a computer device connected to the Intranet using a centralized communication cable device (such as switch or hub).

In addition, testing devices used in assembly lines or research and development often need to be monitored through the central communication cable device. Generally, device management allocates a virtual Internet Protocol (IP) address to one computer device (computer hardware device or network device) and establishes username and password information for each user. Enterprise resources are managed centrally by several hosts. A user generally must successfully login the administrator server to be authorized to use the enterprise resources or access other users' files. The administrator server records the media access control (MAC) address and the IP address of a user's computer devices (computer hardware device or network device) in a database after the user logs in, and then compares it with data from the database to determine whether the device is authorized.

FIG. 1 is a diagram showing unauthorized hardware devices connected to an authorized hardware device in a local area network. In FIG. 1, hardware devices 110, 120, 130, and 140 are authorized, but unauthorized hardware devices 115 has been installed therebetween, creating numerous problems. Availability is threatened, since the IP address count for the network segment exceeds a maximum, and potential error signals from unauthorized hardware devices can disrupt network stability. Finally, security control is compromised, since administration has no control over the connection, and further, any wireless network devices (not shown) attached to the device can transmit data uncontrollably outside the environment.

Hence, a wide range of threats to the stability and functionality of the network is presented.

### SUMMARY OF THE INVENTION

Accordingly, an object of the present invention is to provide a method for detecting unauthorized hardware devices in a local area network.

To achieve the foregoing and other objects, one embodiment of the present invention provides a method for detecting unauthorized hardware devices. First, a SNMP (simple network management protocol) walk function from SNMP libraries scans ports of authorized hardware devices to obtain MAC addresses thereof. Next, an uplink port of each authorized network device is filtered to acquire a first MAC address list in which authorized ports with more than two MAC addresses are listed.

The number of authorized MAC addresses is calculated, and a second MAC address list, containing MAC addresses for ports for all network devices, authorized and unauthorized, is acquired. The number of ports with more than two MAC addresses on the first MAC address list is subtracted from the number of ports with more than two MAC addresses on the second MAC address list to obtain a listing of unauthorized MAC addresses.

The unauthorized MAC addresses are compared with MAC addresses in a routing entry table to obtain Internet protocol addresses of unauthorized hardware devices.

User information for the unauthorized hardware devices is found by SNMP or WINS services in accordance with the Internet protocol address of the unauthorized hardware devices.

Another embodiment of the present invention provides a system for detecting an unauthorized hardware device comprising a device detection unit and a device processing unit.

The device detection unit uses a SNMP walk function from SNMP libraries to scan ports of authorized hardware devices to obtain MAC addresses of the authorized hardware devices. Next, the uplink port of each authorized network device is filtered to acquire a first MAC address list in which authorized ports with more than two MAC addresses are listed.

The number of MAC addresses of ports of authorized network devices is calculated, and then a second MAC address list in which MAC addresses of ports for all network devices, authorized and unauthorized, is acquired, comprising the ports with more than two MAC addresses.

The device processing unit subtracts the number of ports with more than two MAC addresses on the first MAC address list from the number of ports with more than two MAC addresses on the second MAC address list to obtain a listing of unauthorized MAC addresses.

The unauthorized MAC addresses are compared with MAC addresses in a routing entry table to obtain Internet protocol addresses of unauthorized hardware devices.

User information for the unauthorized hardware devices is found by SNMP or WINS services in accordance with the IP address of the unauthorized hardware devices.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 (PRIOR ART) is a diagram showing an unauthorized hardware devices connected to authorized hardware devices in a local area network;

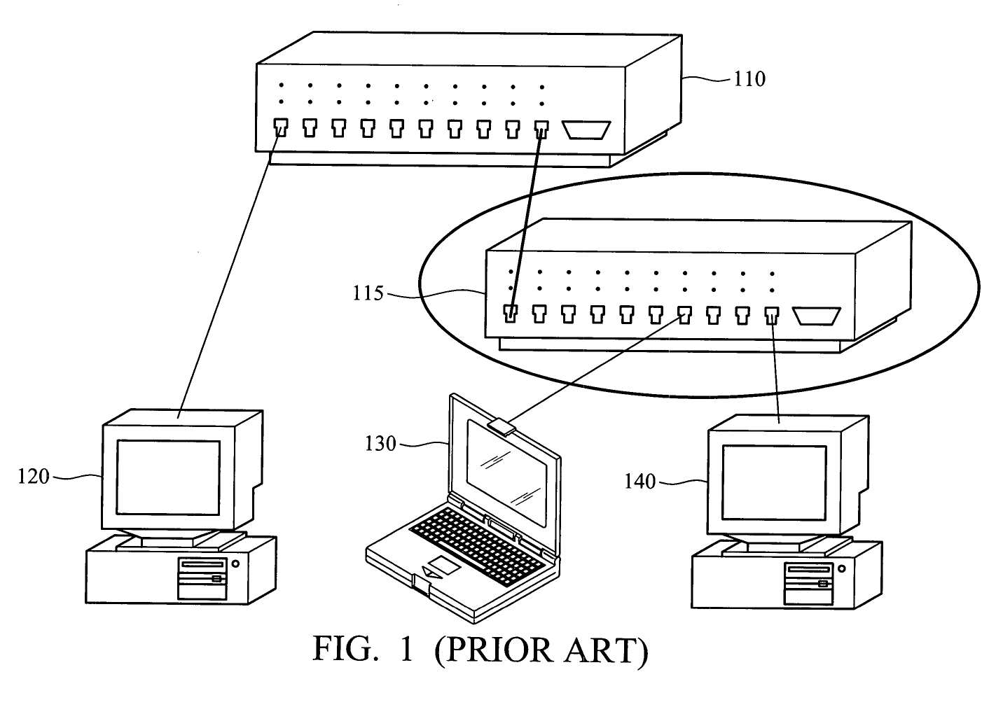

FIG. 2 is a diagram showing the architecture of a system for utilizing SNMP to detect unauthorized hardware devices of one embodiment of the present invention;

FIG. 3 is a flowchart of a method for detecting unauthorized hardware devices utilizing SNMP of one embodiment of the present invention.

### DETAILED DESCRIPTION OF THE INVENTION

The present invention provides a system and method of detecting unauthorized hardware devices in a Local Area Network (LAN). At least two media access control (MAC) addresses are preferably assigned to every port of a network device (such as a switch), the first for the port of the centralized communication cable device, and the second for the computer hardware device. More than two MAC addresses can be assigned per port if the port has additional centralized communication cable devices to which other computer hardware devices are connected. A system uses relevant communication protocol (such as SNMP) to identify unauthorized network devices or computer hardware devices, and a monitoring system issues warning messages to users thereof and to administrators to terminate the detection procedure.

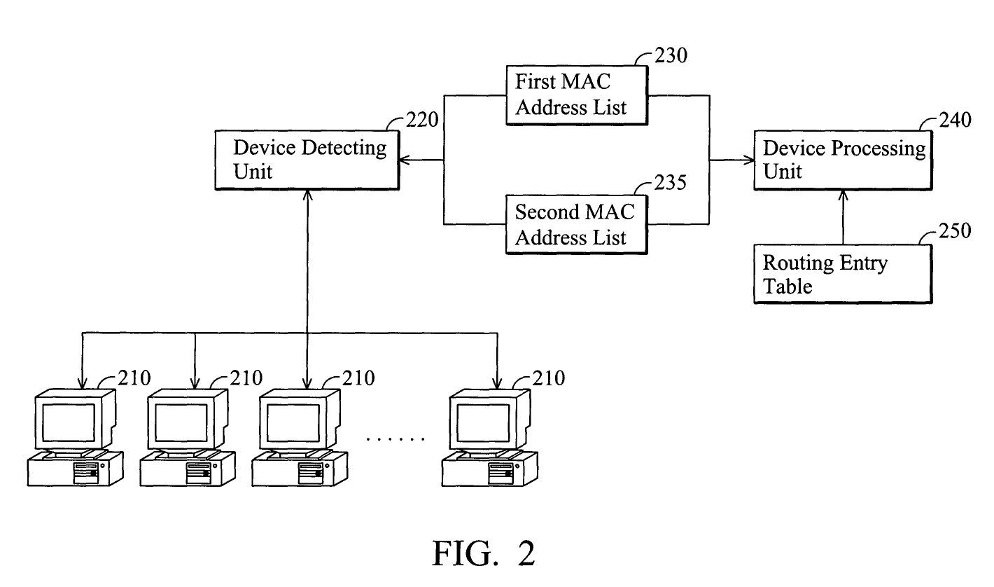

FIG. 2 is a diagram showing the architecture of a system for utilizing SNMP to detect unauthorized hardware devices in accordance with one embodiment of the present invention.

The architecture comprises a device detection unit 220 and a device-processing unit 240. The device detection unit 220 may utilize an SNMP walk function from SNMP libraries to scan ports for all known authorized network devices in a LAN though an authorized network device (such as a switch) to obtain MAC addresses thereof. As is known, is a commonly used service that provides network management and monitoring capabilities. SNMP offers the capability to poll-networked devices and monitor data such as utilization and errors for various systems on the host. SNMP is also capable changing the configurations on the host, allowing the remote management of the network device. The protocol uses a community string for authentication from the SNMP client to the SNMP agent on the managed device. SNMP was designed to provide a means of managing and monitoring diverse network devices. Communication between a client and server is accomplished using a message called a protocol data unit (PDU). There are four commonly used SNMP PDUs: a get request, a get next request, a set request, and a trap message. The get request is used to fetch a specific value that is stored in a table on the server. As is known, a SNMP walk function is similar to a get request, and allows a requesting device to “walk” through and obtain a number of specified variables. In the context of the illustrated embodiments, the walk function may be used to scan ports of otherwise unknown network devices to identify and obtain the MAC addresses of those ports.

While two MAC addresses are assigned on every port, some ports can carry more, under special conditions. The device detection unit 220 filters the uplink port of each authorized network device to obtain a first MAC address list 230 in which ports with more than two authorized MAC addresses are listed.

Next, the device detection unit 220 calculates the number of MAC addresses of the ports of existing network devices to obtain a second MAC address list 235, comprising addresses for all hardware devices 210 (authorized or unauthorized).

The device processing unit 240 subtracts the number of ports with more than two MAC addresses on the first MAC address list 230 from the number of ports with more than two MAC addresses on the second MAC address list 235 to obtain a listing of unauthorized MAC addresses and retrieves information for corresponding unauthorized hardware devices 210.

The device processing unit 240 compares the unauthorized MAC addresses with MAC addresses listed in routing entry table 250 to obtain IP addresses of hardware devices 210 with unauthorized MAC addresses. User information for the unauthorized hardware devices 210 is found by SNMP or WINS services in accordance with the IP address of the unauthorized hardware devices 210.

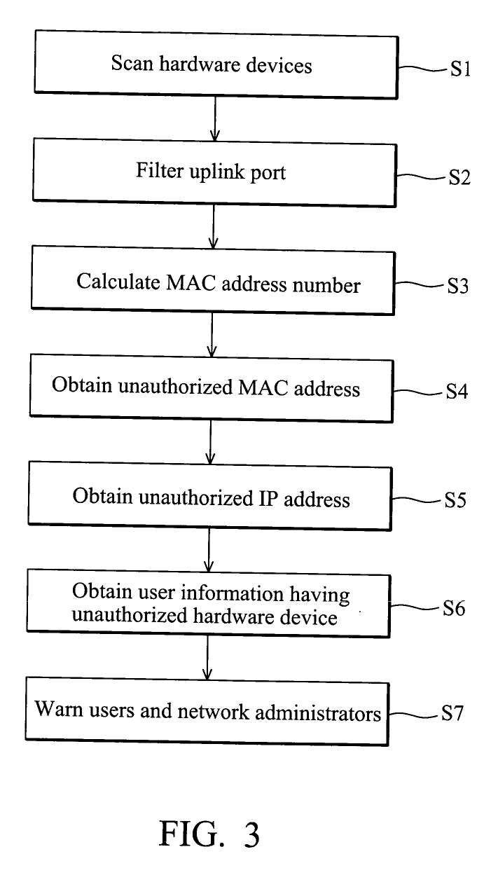

FIG. 3 is a flowchart of the method for detecting unauthorized hardware devices utilizing SNMP, in accordance with one embodiment of the present invention.

In step S1, the system recursively scans all network and computer devices in a LAN through SNMP. The SNMP work mode sends messages to a management system, and an agent updates the management information base (MIB) In the management system. Every authorized network device is stored in the management information base. As a result, ports for all centralized communication cable devices (e.g., switch or hub) are scanned by an appropriate mechanism, such as a SNMP walk function, returning scanned objects from SNMP libraries through any device to acquire MAC addresses of the port and computer hardware devices connected to the port. The scanned network and device data is returned to the system to acquire relevant information for all known authorized network devices or computer hardware devices.

In step S2, the system filters the uplink ports of authorized network devices. A specific port is required to connect centralized communication cable devices to each other—e.g., the uplink port. If a user connects an authorized centralized communication cable device (herein second centralized communication cable device) to the original centralized communication cable device (herein first centralized communication cable device) and then connects the hardware device (herein user device) to the second centralized communication cable device, there are three MAC addresses that can be scanned from the uplink port of the first centralized communication cable device after the filtering action. These three MAC addresses, on the uplink port of the first centralized communication cable device, represent authorized network or computer hardware devices.

In step S3, the system calculates the number of MAC addresses on ports of network devices. The system calculates the number of MAC addresses on ports by scanning the ports for all the centralized communication cable devices though the SNMP walk function from SNMP libraries. This step locates all network devices or computer hardware devices in the local area network, both authorized and unauthorized.

In step S4, the method of one embodiment subtracts the number of the ports with more than two MAC addresses, thereby acquiring the total number of network and computer devices, including those with more than two MAC addresses. The scanned MAC addresses are compared with the MAC addresses in a database to acquire information for unauthorized hardware devices, after subtracting ports of authorized network devices with more than two MAC addresses. The system eliminates these ports, leaving only ports connecting unauthorized hardware devices.

In step S5, the MAC addresses for the remaining ports are compared with a routing entry table to obtain IP addresses of unauthorized network devices.

In step S6, user information of the unauthorized hardware devices is determined using appropriate services, such as SNMP or WINS services. The database records the user information, such as MAC addresses or IP addresses.

In step S7, the system issues warnings to users and advises network administrators of the unauthorized devices.

The system and method of the present invention, for detecting unauthorized hardware devices, is uniquely effective in heightening physical and informational security in a LAN. By providing more comprehensive control of networked assets, the invention also reduces the risk of system damage, stabilizes the network, and reduces administrative workload.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation to encompass all such modifications and similar arrangements.

1. A method for detecting unauthorized hardware devices in a local area network, comprising steps of:
scanning ports of a plurality of hardware devices to retrieve MAC addresses thereof;
filtering an uplink port on each of the hardware devices to acquire a first MAC address list;
calculating the number of MAC addresses of the filtered ports to acquire a second MAC address list; and
subtracting the number of ports with more than two MAC addresses on the first MAC address list from the number of ports with more than two MAC addresses on the second MAC address list, thereby obtaining at least one unauthorized MAC address.

2. The method as claimed in claim 1, further comprising steps of:
comparing the MAC addresses of the unauthorized hardware devices with MAC addresses in a routing entry table to obtain Internet Protocol (IP) addresses of the unauthorized hardware devices; and
acquiring user information for the unauthorized hardware devices by SNMP or WINS services in accordance with the IP address of the unauthorized hardware devices.

3. The method as claimed in claim 1, wherein in the scanning step, the ports of the authorized hardware devices are recursively scanned by one of the authorized network devices.

4. The method as claimed in claim 1, wherein in the scanning step, the MAC addresses of authorized hardware devices are stored in a database.

5. The method as claimed in claim 1, wherein in the scanning step, the ports of authorized network devices are scanned by simple network management protocol.

6. The method as claimed in claim 1, wherein a simple network management protocol is used in the calculating step.

7. A system for detecting unauthorized hardware devices in a local area network, comprising:
a device detection unit for scanning a plurality of ports of a plurality of hardware devices to retrieve MAC addresses thereof, filtering an uplink port of each hardware device to acquire a first MAC address list, and calculating the number of MAC addresses of the ports of the network devices to acquire a second MAC address list; and
a device processing unit, coupled with the device detection unit, for subtracting the number of ports with more than two MAC addresses on the first MAC address list from the number of ports with more than two MAC addresses on the second MAC address list, thereby obtaining at least one unauthorized MAC address.

8. The system as claimed in claim 7, wherein the device processing unit compares the MAC addresses of the unauthorized hardware devices with MAC addresses in a routing entry table to obtain Internet Protocol (IP) addresses of unauthorized hardware devices, and acquire user information of the unauthorized hardware devices by SNMP or WINS services.

9. The system as claimed in claim 7, wherein the device detection unit recursively scans the ports of the hardware devices.

10. The system as claimed in claim 7, wherein the device detection unit stores the MAC addresses of the hardware devices in a database.

11. The system as claimed in claim 7, wherein the device detection unit scans the ports of the network devices by simple network management protocol.

12. A storage medium containing a stored computer program providing a method for detecting unauthorized hardware devices, comprising using a computer to perform the steps of:
scanning a plurality of ports of a plurality of hardware devices to retrieve MAC addresses thereof;
filtering an uplink port of each hardware device to acquire a first MAC address list;
calculating the number of MAC addresses of the ports of the network devices to acquire a second MAC address list; and
subtracting the number of ports with more than two MAC addresses on the first MAC address list from the number of ports with more than two MAC addresses on the second MAC address list, thereby obtaining at least one unauthorized MAC address.

13. The storage medium as claimed in claim 12, further comprising steps of:
comparing the MAC addresses of the unauthorized hardware devices with MAC addresses in a routing entry table to obtain Internet Protocol (IP) addresses of unauthorized hardware devices; and
acquiring user information of the unauthorized hardware devices by SNMP or WINS services in accordance with the IP address of the unauthorized hardware devices.

14. The storage medium as claimed in claim 12, wherein the ports of the hardware devices are recursively scanned by one of the authorized network devices.

15. The storage medium as claimed in claim 12, wherein the MAC addresses of the hardware devices are stored in a database.

16. The storage medium as claimed in claim 12, wherein the ports of the network devices are scanned by simple network management protocol.
